(19) United States
(12) Patent Application Publication
(10) Pub. No.: US 2015/0022483 A1
(43) Pub. Date: Jan. 22, 2015

(54) TOUCH DISPLAY APPARATUS

(71) Applicant: Novatek Microelectronics Corp., Hsinchu (TW)

(72) Inventors: Chih-Chang Lai, Taichung City (TW); Tien-Nan Wang, Taichung City (TW)

(73) Assignee: Novatek Microelectronics Corp., Hsinchu (TW)

(21) Appl. No.: 14/020,909

(22) Filed: Sep. 9, 2013

(30) Foreign Application Priority Data
Jul. 16, 2013 (TW) 102125443

(51) Int. Cl. G06F 3/044

(52) U.S. Cl. CPC G06F 3/044
USPC 345/174

(57) ABSTRACT

A touch display apparatus includes a display panel, a cover plate, a capacitive touch-sensing unit and an electromagnetic touch-sensing unit. The cover plate is disposed above the display panel. The capacitive touch-sensing unit is disposed between the cover plate and the display panel. The electromagnetic touch-sensing unit is disposed between the capacitive touch-sensing unit and the display panel. The capacitive touch-sensing unit and the electromagnetic touch-sensing unit are formed of a transparent conductive material.

### CROSS-REFERENCE TO RELATED APPLICATION

This application claims the priority benefit of Taiwan application serial no. 102125443, filed on Jul. 16, 2013. The entirety of the above-mentioned patent application is hereby incorporated by reference herein and made a part of this specification.

### BACKGROUND OF THE INVENTION

1. Field of the Invention

The invention relates to an electronic apparatus, and particularly relates to a touch display apparatus.

2. Description of Related Art

Based on different sensing types, touch-sensing panels can be generally categorized into resistance touch-sensing panels, capacitive touch-sensing panels, optical touch-sensing panels, acoustic-wave touch-sensing panels and electromagnetic touch-sensing panels. Since capacitive touch-sensing panels have the advantages such as quick response, desirable reliability, and high durability, and electromagnetic touch-sensing panels have the advantages such as being capable of sensing and displaying dragging tracks of electromagnetic pens, capacitive touch-sensing panels and electromagnetic touch-sensing panels have been broadly used in electronic products.

To enable a touch display apparatus to have a sensing function of finger touch and a sensing function to receive an electromagnetic pen input at the same time, an electromagnetic touch-sensing panel and a capacitive touch-sensing panel need to be respectively manufactured before being assembled to a display panel. Specifically, an electromagnetic sensing plate in the electromagnetic touch-sensing panel is formed of an opaque X-axis sensing coil and an opaque Y-axis sensing coil disposed on a substrate. Therefore, the electromagnetic touch-sensing panel needs to be configured below the display panel to prevent light from being blocked. On the other hand, an X sensing series and a Y sensing series that are respectively disposed on two substrates in the capacitive touch-sensing panel are formed of a transparent conductive material. Therefore, the capacitive touch-sensing panel may be configured above the display panel. Therefore, the touch display apparatus having a sensing function of finger-touch and a sensing function to receive an electromagnetic pen input at the same time needs five substrates (two substrates for the display panel, another two substrates for the capacitive touch-sensing panel, and one substrate for the electromagnetic touch-sensing panel), making it difficult to reduce the thickness of the touch display apparatus and meet the requirement of thinness.

### SUMMARY OF THE INVENTION

The invention provides a touch display apparatus having a sensing function of finger-touch and a sensing function to receive an electromagnetic pen input at the same time and having a thinner thickness that meets the tendency of pursing thickness nowadays.

A touch display apparatus of the invention includes a display panel, a cover plate, a capacitive touch-sensing unit, and an electromagnetic touch-sensing unit. The cover plate is disposed above the display panel. The capacitive touch-sensing unit is disposed between the cover plate and the display panel. The electromagnetic touch-sensing unit is disposed between the capacitive touch-sensing unit and the display panel, wherein the electromagnetic touch-sensing unit and the capacitive touch-sensing unit are formed of a transparent conductive material.

In an embodiment of the invention, the capacitive touch-sensing unit is directly disposed on the cover plate.

In an embodiment of the invention, the touch display apparatus further includes a flexible circuit board and at least one touch-sensing driving chip. The flexible circuit board has a first connection part and a second connection part. The capacitive touch-sensing unit is electrically connected with the electromagnetic touch-sensing via the first connection part and the second connection part. The touch-sensing driving chip is disposed on the flexible circuit board and electrically connected with the flexible circuit board.

In an embodiment of the invention, the touch display apparatus further includes a transparent substrate. The transparent substrate is disposed between the capacitive touch-sensing unit and the electromagnetic touch-sensing unit, and the electromagnetic touch-sensing unit is directly disposed on the transparent substrate. The first connection part and the second connection part of the flexible circuit board are respectively disposed on the cover plate and the transparent substrate.

In an embodiment of the invention, the touch display apparatus further includes a transparent film. The transparent film is disposed between the capacitive touch-sensing unit and the electromagnetic touch-sensing unit, and the electromagnetic touch-sensing unit is directly disposed on the transparent film. The first connection part and the second connection part of the flexible circuit board are respectively disposed on the cover plate and the transparent film.

In an embodiment of the invention, the electromagnetic touch-sensing unit is built in the display panel.

In an embodiment of the invention, the touch display apparatus further includes a first flexible circuit board, a second flexible circuit board, a first touch-sensing driving chip and a second touch-sensing driving chip. The first flexible circuit board is disposed on the cover plate and electrically connected with the capacitive touch-sensing unit. The second flexible circuit board is disposed on the display panel and electrically connected with the electromagnetic touch-sensing unit. The first touch-sensing driving chip is disposed on the first flexible circuit board and electrically connected with the first flexible circuit board. The second touch-sensing driving chip is disposed on the second flexible circuit board and electrically connected with the second flexible circuit board.

In an embodiment of the invention, the touch display apparatus further includes a first transparent film and a second transparent film. The first transparent film is disposed between the capacitive touch-sensing unit and the electromagnetic touch-sensing unit, and the capacitive touch-sensing unit is directly disposed on the first transparent film. The second transparent film is disposed between the electromagnetic touch-sensing unit and the display panel, and the electromagnetic touch-sensing unit is directly disposed on the second transparent film.

In an embodiment of the invention, the touch display apparatus further includes a flexible circuit board and at least one touch-sensing driving chip. The flexible circuit board has a first connection part and a second connection part, wherein the first connection part and the second connection part are respectively located on the first transparent film and the second transparent film, and the capacitive touch-sensing unit is electrically connected with the electromagnetic touch-sensing unit via the first connection part and the second connection part. The touch-sensing driving chip is disposed on the flexible circuit board and electrically connected with the flexible circuit board.

In an embodiment of the invention, the display panel includes a first substrate and a second substrate facing each other. The second substrate is located between the cover plate and the first substrate, the capacitive touch-sensing unit is directly disposed on a side of the second substrate relatively away from the cover plate, and the electromagnetic touch-sensing unit is directly disposed on a side of the first substrate relatively adjacent to the capacitive touch-sensing unit.

In an embodiment of the invention, the touch display apparatus further includes a flexible circuit board and at least one touch-sensing driving chip. The flexible circuit board is disposed on the first substrate of the display panel, and electrically connected with the capacitive touch-sensing unit and the electromagnetic touch-sensing unit. The touch-sensing driving chip is disposed on the flexible circuit board and electrically connected with the flexible circuit board.

In an embodiment of the invention, the capacitive touch-sensing unit includes a plurality of first sensing series and a plurality of second sensing series. Each of the first sensing series includes a plurality of first sensing pads and a plurality of first bridging lines that connect the first sensing pads in series along a first direction. Each of the second sensing series includes a plurality of second sensing pads and a plurality of second bridging lines that connect the second sensing pads in series along a second direction. The second sensing series do not contact the first sensing series, and the first direction intersects the second direction.

In an embodiment of the invention, the capacitive touch-sensing unit includes a plurality of first coils and a plurality of second coils. Each of the first coils has a first connection part and a first coil part connecting the first connection part and extending along the first direction, wherein orthographic projection areas on the display panel taken up by any two adjacent of the first coil parts are partially overlapped. Each of the second coils has a second connection part and a second coil part connecting the second connection part and extending along a second direction. The first direction intersects the second direction, and orthographic projection areas on the display panel taken up by any two adjacent of the second coil parts are partially overlapped.

In an embodiment of the invention, the touch display apparatus further includes a display driving chip. The display driving chip is disposed on the display panel and electrically connected with the display panel.

In an embodiment of the invention, the transparent conductive material includes indium tin oxide, metal mesh, nano argentum, or carbon nano tube, etc.

Accordingly, since the electromagnetic touch-sensing unit and the capacitive touch-sensing unit are formed of a transparent conductive material, the electromagnetic touch-sensing unit may be disposed between the cover plate and the display panel and form an integrative touch-sensing panel with the capacitive touch-sensing unit. Alternatively, the electromagnetic touch-sensing unit may be built in or integrated into the display panel, so as to reduce use of a substrate or a film. Compared to a conventional opaque electromagnetic touch-sensing unit that requires to be disposed below the display panel, the touch display apparatus of the invention reduces the overall thickness, thereby meeting the tendency of pursuing thinness.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1A is a cross-sectional schematic view illustrating a touch display apparatus according to an embodiment of the invention.

FIG. 1B is a top schematic view illustrating a capacitive touch-sensing unit of the touch display apparatus of FIG. 1A.

FIG. 1C is a top schematic view illustrating an electromagnetic touch-sensing unit of the touch display apparatus of FIG. 1A.

FIG. 2 is a cross-sectional view illustrating a touch display apparatus according to another embodiment of the invention.

FIG. 3 is a cross-sectional view illustrating a touch display apparatus according to another embodiment of the invention.

FIG. 4 is a cross-sectional view illustrating a touch display apparatus according to another embodiment of the invention.

FIG. 5 is a cross-sectional view illustrating a touch display apparatus according to another embodiment of the invention.

### DESCRIPTION OF EMBODIMENTS

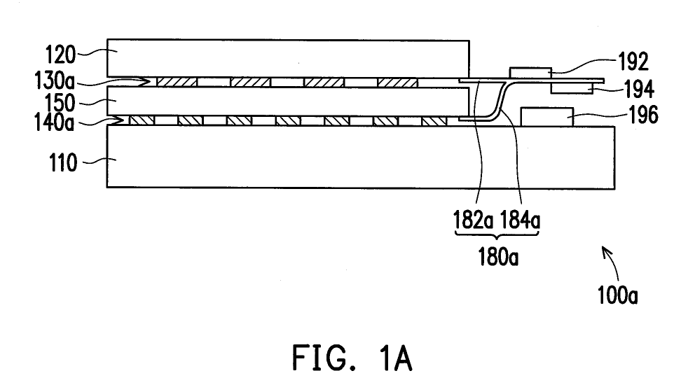

FIG. 1A is a cross-sectional schematic view illustrating a touch display apparatus according to an embodiment of the invention. FIG. 1B is a top schematic view illustrating a capacitive touch-sensing unit of the touch display apparatus of FIG. 1A. FIG. 1C is a top schematic view illustrating an electromagnetic touch-sensing unit of the touch display apparatus of FIG. 1A. Referring to FIG. 1A at first, in this embodiment, a touch display apparatus 100a includes a display panel 110, a cover plate 120, a capacitive touch-sensing unit 130a, and an electromagnetic touch-sensing unit 140a. The cover plate 120 is disposed above the display panel 110. The capacitive touch-sensing unit 130a is disposed between the cover plate 120 and the display panel 110. The electromagnetic touch-sensing unit 140a is disposed between the capacitive touch-sensing unit 130a and the display panel 110. More specifically, the electromagnetic touch-sensing unit 140a is formed of metal mesh, for example, and the capacitive touch-sensing unit 130a is formed of indium tin oxide (ITO), for example. In other words, the electromagnetic touch-sensing unit 140a and the capacitive touch-sensing unit 130a are formed of a transparent conductive material.

More specifically, in this embodiment, the display panel 110 may be a liquid crystal display panel, an organic electroluminescent display panel, a plasma display panel, an electronic paper display panel, an electro-wetting display panel, an electrophoresis display panel, or a compound display panel. The cover plate 120 may be a transparent glass or plastic plate. The capacitive touch-sensing unit 130a is directly disposed on the cover plate 120. As shown in FIG. 1B, the capacitive touch-sensing unit 130a is formed of a plurality of first sensing series 132 and a plurality of second sensing series 134. Each of the first sensing series 132 includes a plurality of first sensing pads 132a and a plurality of first bridging lines 132b that connect the first sensing pads 132a in series along a first direction D1. Each of the second sensing series 134 includes a plurality of second sensing pads 134a and a plurality of second bridging lines 134b that connect the second sensing pads 134a in series along a second direction D2. The second sensing series 134 do not contact the first sensing series 132, and the first direction D1 intersects the second direction D2. In other embodiments, the capacitive touch-sensing unit 130a may be a capacitive touch-sensing unit in a form other than a projective capacitive touch-sensing unit shown in this embodiment. In addition, shapes of the first and second sensing pads 132a and 134a, such as a rhombic shape, a triangular shape, or a straight-line shape, etc., are not limited.

As shown in FIGS. 1A and 1C, the touch display apparatus 100a of this embodiment further includes a transparent substrate 150. The transparent substrate 150 is disposed between the capacitive touch-sensing unit 130a and the electromagnetic touch-sensing unit 140a, and the electromagnetic touch-sensing unit 140a is directly disposed on the transparent substrate 150. In this embodiment, the electromagnetic touch-sensing unit 140a is formed by a plurality of first coils 142 and a plurality of second coils 144. Each of the first coils 142 has a first connection part 142a and a first coil part 142b connecting the first connection part 142a and extending along the first direction D1, wherein orthographic projection areas on the display panel 110 taken up by any two adjacent of the first coil parts 142b are partially overlapped. Each of the second coils 144 has a second connection part 144a and a second coil part 144b connecting the second connection part 144a and extending along the second direction D2, wherein orthographic projection areas on the display panel 110 taken up by any two adjacent of the second coil parts 144b are partially overlapped. It should be noted that the invention does not impose a limitation on shapes of the first coil parts 142b of the first coils 142 and the second coil parts 144b of the second coils 144. Even though the first and second coil parts 142b and 144b are embodied herein as rectangular, in other embodiments not shown herein, the shapes of the first and second coil parts 142b and 144b may be in a circular shape or in other polygonal shapes. Such shapes are also possible technical solutions of the invention and fall within the scope that the invention intends to protect.

Besides, the touch display apparatus 100a of this embodiment further includes a flexible circuit board 180a and at least one touch-sensing driving chip (two touch-sensing driving chips 192 and 194 are schematically shown in FIG. 1A). The flexible circuit board 180a has a first connection part 182a and a second connection part 184a, wherein the first connection part 182a and the second connection part 184a are respectively disposed on the cover plate 120 and the transparent substrate 150. The capacitive touch-sensing unit 130a and the electromagnetic touch-sensing 140a are electrically connected via the first connection part 182a and the second connection part 184a. The touch-sensing driving chips 192 and 194 are disposed on the flexible circuit board 180a and electrically connected with the flexible circuit board 180a, so as to drive the capacitive touch-sensing unit 130a and the electromagnetic touch-sensing unit 140a respectively. In addition, the touch display apparatus 100a further includes a display driving chip 196, wherein the display driving chip 196 is disposed on the display panel 110 and electrically connected with the display panel 110, so as to drive the display panel 110.

In particular, the electromagnetic touch-sensing unit 140a and the capacitive touch-sensing 130a of this embodiment are formed of a transparent conductive material, wherein the transparent conductive material is indium tin oxide, metal mesh, carbon nano tube, or nano argentum, for example. Since the electromagnetic touch-sensing unit 140a and the capacitive touch-sensing unit 130a of this embodiment are formed of a transparent conductive material, the electromagnetic touch-sensing unit 140a may be disposed between the cover plate 120 and the display panel 110, and the cover plate 120, the capacitive touch-sensing unit 130a, the transparent substrate 150, and the electromagnetic touch-sensing unit 140a define an integrative touch-sensing panel. Compared to a conventional opaque electromagnetic touch-sensing unit that requires to be disposed below the display panel, the integrative touch-sensing panel of this embodiment at least reduces use of a substrate or a film, thereby effectively reducing an overall thickness of the touch display apparatus 100a and meeting the tendency of pursuing thinness.

It should be noted that the reference numerals and a part of the contents in the previous embodiment are used in the following embodiments, in which identical reference numerals indicate identical or similar components, and repeated description of the same technical contents is omitted. For a detailed description of the omitted parts, reference can be found in the previous embodiment, and no repeated description is contained in the following embodiments.

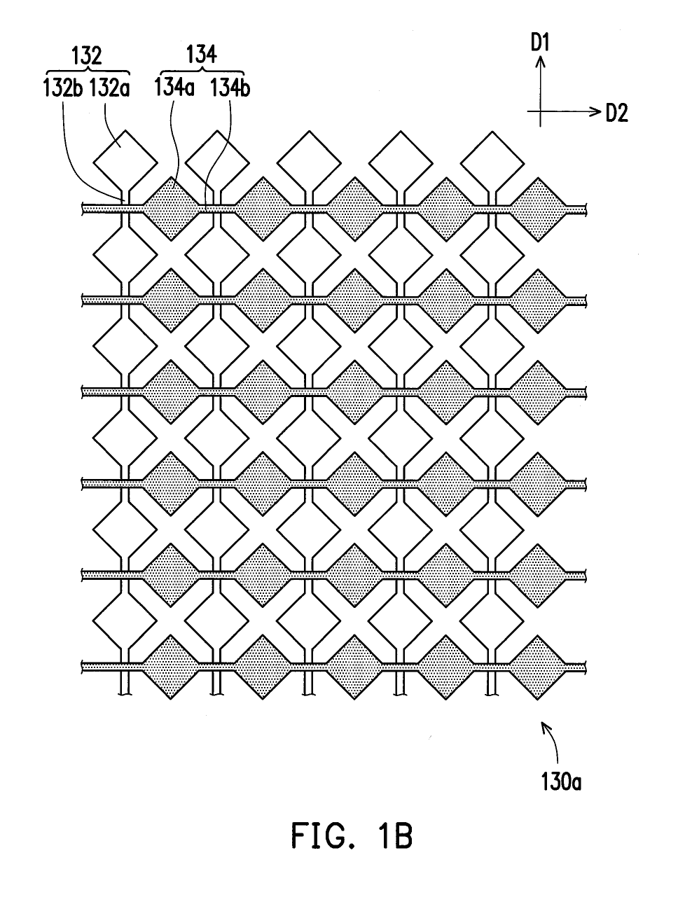

FIG. 2 is a cross-sectional view illustrating a touch display apparatus according to another embodiment of the invention. A touch display apparatus 100b of this embodiment is similar to the touch display apparatus 100a shown in FIG. 1A, with a mere difference that in the touch display apparatus 100b in this embodiment, a transparent film 160 is used to replace the transparent substrate 150 in FIG. 1A. More specifically, the transparent film 160 is disposed between the capacitive touch-sensing unit 130a and an electromagnetic touch-sensing unit 140b, and the electromagnetic touch-sensing unit 140b is directly disposed on the transparent film 160. The first connection part 182a and the second connection part 184a of the flexible circuit board 180a are respectively disposed on the cover plate 120 and the transparent film 160. Since a thickness of the transparent film 160 is relatively thinner than a thickness of a conventional substrate, an integrative touch-sensing panel formed by the cover plate 120, the capacitive touch-sensing unit 130a, the transparent film 160, and the electromagnetic touch-sensing unit 140b may have a thinner thickness. Therefore, the touch display apparatus 100b of this embodiment has a reduced overall thickness, thereby meeting the tendency of pursuing thinness. In addition, in this embodiment, only an integrative touch-sensing driving chip 198 is used to drive the capacitive touch-sensing unit 130a and the electromagnetic touch-sensing unit 140b. Therefore, a layout area taken up in the flexible circuit board 180a and a production cost, including costs for bonding (the prior art requires to bond two ICs) and packaging (the prior art requires to package two ICs), may be reduced.

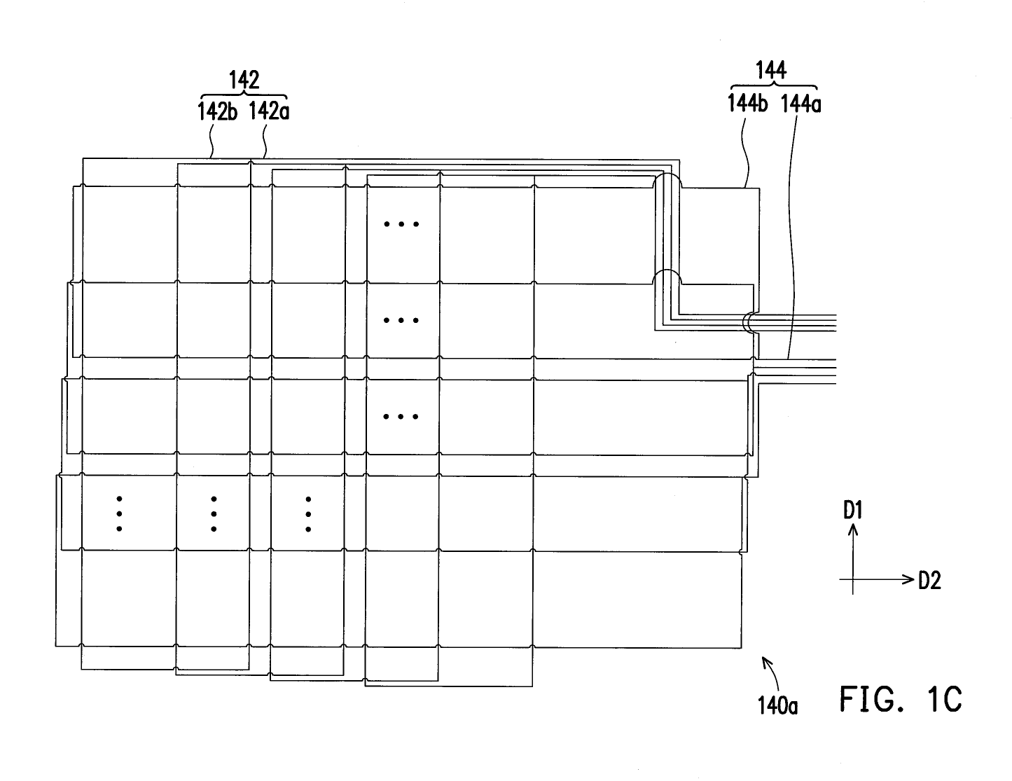

FIG. 3 is a cross-sectional view illustrating a touch display apparatus according to another embodiment of the invention. A touch display apparatus 100c of this embodiment is similar to the touch display apparatus 100a shown in FIG. 1A, with a mere difference that a capacitive touch-sensing unit 130c and an electromagnetic touch-sensing unit 140c in this embodiment are respectively not disposed on the cover plate 120 and the transparent substrate 150. Specifically, the touch display apparatus 100c of this embodiment further includes a first transparent film 162 and a second transparent film 164. The first transparent film 162 is disposed between the capacitive touch-sensing unit 130c and the electromagnetic touch-sensing unit 140c, and the capacitive touch-sensing unit 130c is directly disposed on the first transparent film 162. The second transparent film 164 is disposed between the electromagnetic touch-sensing unit 140c and the display panel 110, and the electromagnetic touch-sensing unit 140c is directly disposed on the second transparent film 164. The first connection part 182a and the second connection part 184a of the flexible circuit board 180a are respectively located on the first transparent film 162 and the second transparent film 164, and the capacitive touch-sensing unit 130c and the electromagnetic touch-sensing unit 140c are electrically connected with the integrative touch-sensing driving chip 198 via the first and second connection parts 182a and 184a.

Since a thickness of the first transparent film 162 and a thickness of the second transparent film 164 are relatively thinner than a thickness of a conventional substrate, an integrative touch-sensing panel formed by the cover plate 120, the capacitive touch-sensing unit 130c, the first transparent film 162, the electromagnetic touch-sensing unit 140c, and the second transparent film 164 may have a thinner thickness. Therefore, the touch display apparatus 100c of this embodiment is capable of reducing an overall thickness, thereby meeting the tendency of pursuing thinness. In addition, only the integrative touch-sensing driving chip 198 is used in this embodiment to drive the capacitive touch-sensing unit 130c and the electromagnetic touch-sensing unit 140c. Therefore, the layout area taken up in the flexible circuit board 180a and the production cost, including the costs for bonding (the prior art requires to bond two ICs) and packaging (the prior art requires to package two ICs), may be reduced.

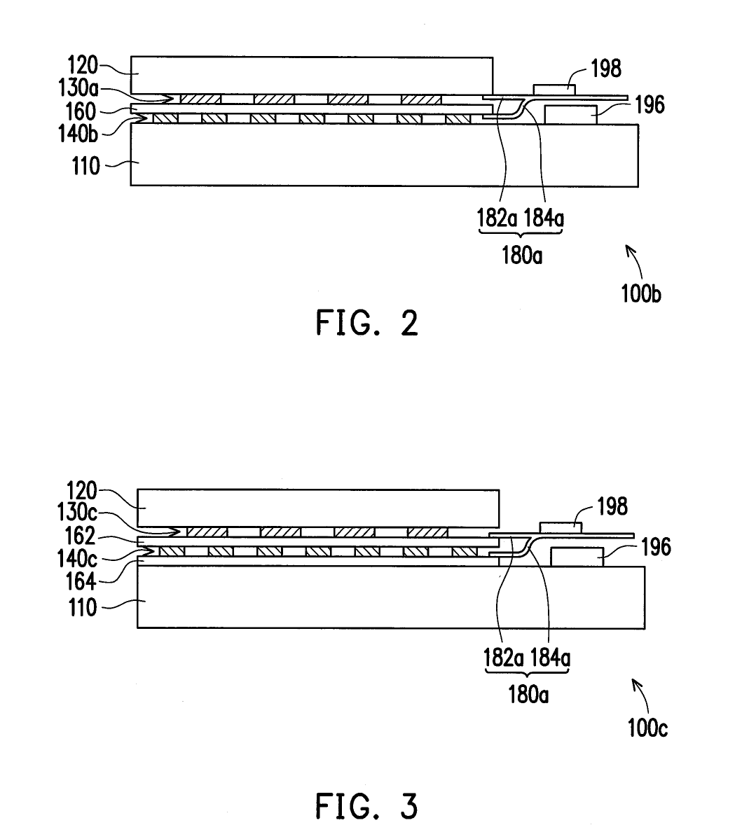

FIG. 4 is a cross-sectional view illustrating a touch display apparatus according to another embodiment of the invention. A touch display apparatus 100d of this embodiment is similar to the touch display apparatus 100a shown in FIG. 1A, with a mere difference that in this embodiment, the transparent substrate 150 is not used, whereas an electromagnetic touch-sensing unit 140d is built in a display panel 110d. Specifically, the display panel 110d of this embodiment is formed of a first substrate 112d and a second substrate 114d, wherein the second substrate 114d is located between the first substrate 112d and the cover plate 120, and the electromagnetic touch-sensing unit 140d may be built in the first substrate 112d or in the second substrate 114d, the invention is not limited thereto. In addition, the touch display apparatus 100d further includes a first flexible circuit board 180b, a second flexible circuit board 180c, a first touch-sensing driving chip 192a and a second touch-sensing driving chip 194a. The first flexible circuit board 180b is disposed on the cover plate 120 and electrically connected with the capacitive touch-sensing unit 130a. The second flexible circuit board 180c is disposed on the first substrate 112d of the display panel 110d and electrically connected with the electromagnetic touch-sensing unit 140d. The first touch-sensing driving chip 192a is disposed on the first flexible circuit board 180b and electrically connected with the first flexible circuit board 180b, so as to drive the capacitive touch-sensing unit 130a. The second touch-sensing driving chip 194a is disposed on the second flexible circuit board 180c and electrically connected with the second flexible circuit board 180c, so as to drive the electromagnetic touch-sensing unit 140d.

Since in this embodiment, the electromagnetic touch-sensing unit 140d is built in the display panel 110d, there is no need to additionally use a substrate or a film. In this way, an overall thickness of the touch display apparatus 100d is effectively reduced, so as to meet the tendency of pursuing thinness.

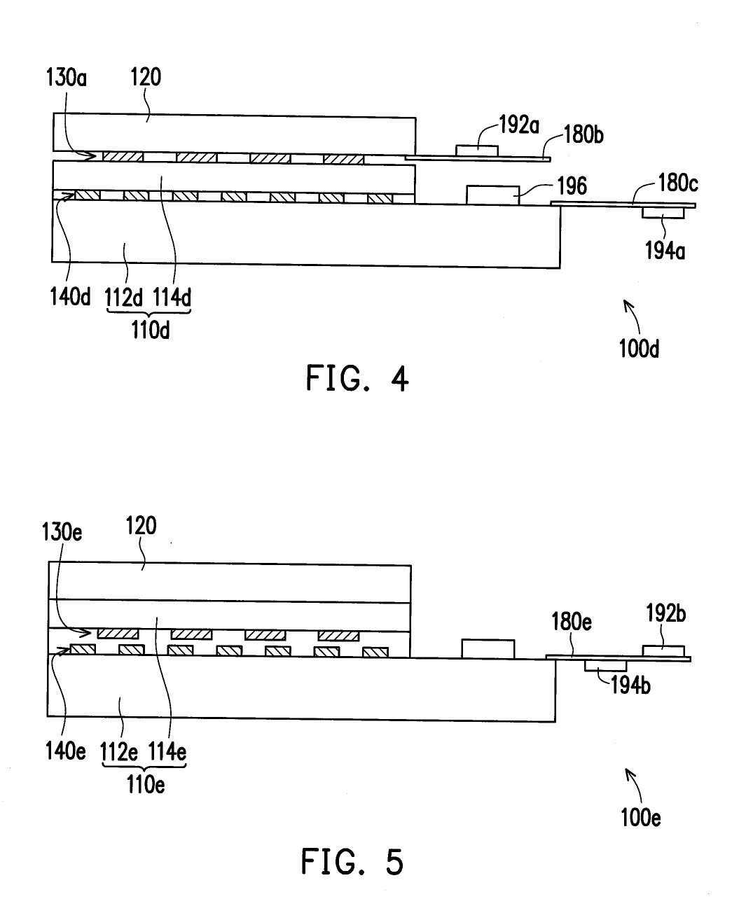

FIG. 5 is a cross-sectional view illustrating a touch display apparatus according to another embodiment of the invention. A touch display apparatus 100e of this embodiment is similar to the touch display apparatus 100d shown in FIG. 4, with a mere difference in that in this embodiment, a capacitive touch-sensing unit 130e is built in a display panel 110e. More specifically, the capacitive touch-sensing unit 130e is directly disposed on a side of a second substrate 114e of the display panel 110e relatively away from the cover plate 120, and the electromagnetic touch-sensing unit 140e is directly disposed on a side of a first substrate 112e of the display panel 110e relatively adjacent to the capacitive touch-sensing unit 130e. A flexible circuit board 180e is disposed on the first substrate 112e of the display panel 110e and electrically connected with the capacitive touch-sensing unit 130e and the electromagnetic touch-sensing unit 140e. A first touch-sensing driving chip 192b and a second touch-sensing driving chip 194b are respectively disposed on the flexible circuit board 180e and electrically connected to the flexible circuit board 180e, so as to respectively drive the capacitive touch-sensing unit 130e and the electromagnetic touch-sensing unit 140e.

Since in this embodiment, the capacitive touch-sensing unit 130e and the electromagnetic touch-sensing unit 140e are built in the display panel 110e, there is no need to additionally use a substrate or a film. In this way, an overall thickness of the touch display apparatus 100e is effectively reduced, so as to meet the tendency of pursuing thinness.

In view of the above, since the electromagnetic touch-sensing unit and the capacitive touch-sensing unit are formed of a transparent conductive material, the electromagnetic touch-sensing unit may be disposed between the cover plate and the display panel and form an integrative touch-sensing panel with the capacitive touch-sensing unit. Alternatively, the electromagnetic touch-sensing unit may be built in or integrated into the display panel, so as to reduce use of a substrate or a film. Compared to a conventional opaque electromagnetic touch-sensing unit that requires to be disposed below the display panel, the touch display apparatus of the invention reduces the overall thickness, thereby meeting the tendency of pursuing thinness.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A touch display apparatus, comprising:
a display panel;
a cover plate, disposed above the display panel;
a capacitive touch-sensing unit, disposed between the cover plate and the display panel; and
an electromagnetic touch-sensing unit, disposed between the capacitive touch-sensing unit and the display panel, wherein the electromagnetic touch-sensing unit and the capacitive touch-sensing unit are formed of a transparent conductive material.

2. The touch display apparatus as claimed in claim 1, wherein the capacitive touch-sensing unit is directly disposed on the cover plate.

3. The touch display apparatus as claimed in claim 2, further comprising:
a flexible circuit board, having a first connection part and a second connection part, wherein the capacitive touch-sensing unit are electrically connected with the electromagnetic touch-sensing unit via the first connection part and the second connection part; and
at least one touch-sensing driving chip, disposed on the flexible circuit board and electrically connected with the flexible circuit board.

4. The touch display apparatus as claimed in claim 3, further comprising:
a transparent substrate, disposed between the capacitive touch-sensing unit and the electromagnetic touch-sensing unit, the electromagnetic touch-sensing unit being directly disposed on the transparent substrate, wherein the first connection part and the second connection part of the flexible circuit board are respectively disposed on the cover plate and the transparent substrate.

5. The touch display apparatus as claimed in claim 3, further comprising:
a transparent film, disposed between the capacitive touch-sensing unit and the electromagnetic touch-sensing unit, the electromagnetic touch-sensing unit being directly disposed on the transparent film, wherein the first connection part and the second connection part of the flexible circuit board are respectively disposed on the cover plate and the transparent film.

6. The touch display apparatus as claimed in claim 2, wherein the electromagnetic touch-sensing unit is built in the display panel.

7. The touch display apparatus as claimed in claim 6, further comprising:
a first flexible circuit board, disposed on the cover plate and electrically connected with the capacitive touch-sensing unit;
a second flexible circuit board, disposed on the display panel and electrically connected with the electromagnetic touch-sensing unit;
a first touch-sensing driving chip, disposed on the first flexible circuit board and electrically connected with the first flexible circuit board; and
a second touch-sensing driving chip, disposed on the second flexible circuit board and electrically connected with the second flexible circuit board.

8. The touch display apparatus as claimed in claim 1, further comprising:
a first transparent film, disposed between the capacitive touch-sensing unit and the electromagnetic touch-sensing unit, the capacitive touch-sensing unit being directly disposed on the first transparent film; and
a second transparent film, disposed between the electromagnetic touch-sensing unit and the display panel, the electromagnetic touch-sensing unit being directly disposed on the second transparent film.

9. The touch display apparatus as claimed in claim 8, further comprising:
a flexible circuit board, having a first connection part and a second connection part, wherein the first connection part and the second connection part are respectively located on the first transparent film and the second transparent film, and the capacitive touch-sensing unit are electrically connected with the electromagnetic touch-sensing unit via the first connection part and the second connection part; and
at least one touch-sensing driving chip, disposed on the flexible circuit board and electrically connected with the flexible circuit board.

10. The touch display apparatus as claimed in claim 1, wherein the display panel comprises a first substrate and a second substrate facing each other, the second substrate being located between the cover plate and the first substrate, the capacitive touch-sensing unit being directly disposed on a side of the second substrate relatively away from the cover plate, and the electromagnetic touch-sensing unit being directly disposed on a side of the first substrate relatively adjacent to the capacitive touch-sensing unit.

11. The touch display apparatus as claimed in claim 10, further comprising:
a flexible circuit board, disposed on the first substrate of the display panel, and electrically connected with the capacitive touch-sensing unit and the electromagnetic touch-sensing unit; and
at least one touch-sensing driving chip, disposed on the flexible circuit board and electrically connected with the flexible circuit board.

12. The touch display apparatus as claimed in claim 1, wherein the capacitive touch-sensing unit comprises:
a plurality of first sensing series, wherein each of the first sensing series comprises a plurality of first sensing pads and a plurality of first bridging lines that connect the first sensing pads in series along a first direction; and
a plurality of second sensing series, wherein each of the second sensing series comprises a plurality of second sensing pads and a plurality of second bridging lines that connect the second sensing pads in series along a second direction, the second sensing series not contacting the first sensing series, and the first direction intersecting the second direction.

13. The touch display apparatus as claimed in claim 1, wherein the electromagnetic touch-sensing unit comprises:
a plurality of first coils, each of the first coils having a first connection part and a first coil part that connects the first connection part and extends along a first direction, wherein orthographic projection areas on the display panel taken up by any two adjacent of the first coil parts are partially overlapped; and
a plurality of second coils, each of the second coils having a second connection part and a second coil part that connects the second connection part and extends along a second direction, wherein the first direction intersects the second direction, and orthographic projection areas on the display panel taken up by any two adjacent of the second coil parts are partially overlapped.

14. The touch display apparatus as claimed in claim 1, further comprising:
a display driving chip, disposed on the display panel and electrically connected with the display panel.

15. The touch display apparatus as claimed in claim 1, wherein the transparent conductive material comprises indium tin oxide, metal mesh, carbon nano tube, or nano argentum.
